(19) United States
(12) Patent Application Publication
(10) Pub. No.: US 2023/0037718 A1
(43) Pub. Date: Feb. 9, 2023

(54) DEVICE WITH DISPLAY

(71) Applicant: Spok, Inc., Alexandria, VA (US)

(72) Inventors: Timothy E. Tindle, Montgomery, TX (US); John de Boer, McKinney, TX (US); Patrick K. Adams, McKinney, TX (US); Craig A. Green, Mesquite, TX (US)

(21) Appl. No.: 17/875,480

(22) Filed: Jul. 28, 2022

Related U.S. Application Data
(60) Provisional application No. 63/226,316, filed on Jul. 28, 2021.

(51) Int. Cl. G09G 5/00

(52) U.S. Cl. CPC G09G 5/003; G09G 2330/023; G09G 2358/00

(57) ABSTRACT

A device includes a display, a monitoring unit configured to obtain a measured value of a power state of the device, and an auxiliary power unit for supplying power to the device when the measured value is less than a minimum operating value. Content on the display is updated with new content when the measured value is less than the minimum operating value.

### FIELD

This disclosure is directed generally to displays, and in particular to systems and methods of modifying the display content based on the status of the power used to operate the device.

### BACKGROUND

Many electronic devices include a display. Some displays do not need power to maintain the image on the display. As a result, these types of displays typically provide very good efficiency. However, one characteristic of these displays is that in the event of a loss of power the display will continue to display the last image. In some applications, sensitive information may be inadvertently displayed by a device and cannot be modified until the device receives power. In other applications, the display may indicate to an observer that the device is On when it is Off. It would be beneficial to provide systems and methods of preventing the inadvertent display of sensitive information or other misinformation by displays that do not require power to continue displaying content.

### SUMMARY

According to one aspect, a device includes a display, a monitoring unit configured to obtain a measured value of a power state of the device, and an auxiliary power unit for supplying power to the device when the measured value is less than a minimum operating value. Content on the display is updated with new content when the measured value is less than the minimum operating value.

According to another aspect, a processor implemented method for modifying the content on the display on a device comprising a display and a processor includes modifying the content on the display in response to a power level of the device being below a minimum operating value.

According to a further aspect, a personal electronic device includes a display that does not require power to continue displaying content and the display is selectively modified in response to a triggering event.

### DESCRIPTION OF THE DRAWINGS

FIG. 1 is a block diagram of components of a device, according to some embodiments.

FIG. 2 is a block diagram of components of a device, according to some embodiments.

FIG. 3 is a block diagram of components of a device, according to some embodiments.

FIG. 4 is an exemplary power level scale for a device, according to some embodiments.

FIG. 5 is a flowchart of an exemplary power-off method, according to some embodiments.

### DETAILED DESCRIPTION

Embodiments of the present disclosure describe features for a device with a display that does not require power to maintain an image/text on the display. This characteristic may confuse a device user because the device can appear to be On even when the device has no power and/or the device is in an Off State. Additionally, there is a risk of inadvertent disclosure of private information due to the continued display of text and images. In one aspect, a device monitors the power state (e.g., voltage and/or current) available to a device and takes action to modify the content displayed by the display (replaces a current image/text with a new image/text) in response to the power or charge state falling below a threshold value or being removed. In addition, in some embodiments, the device will also take action to modify the content being displayed by the display if the device is turned Off and the charge state is greater than the threshold value.

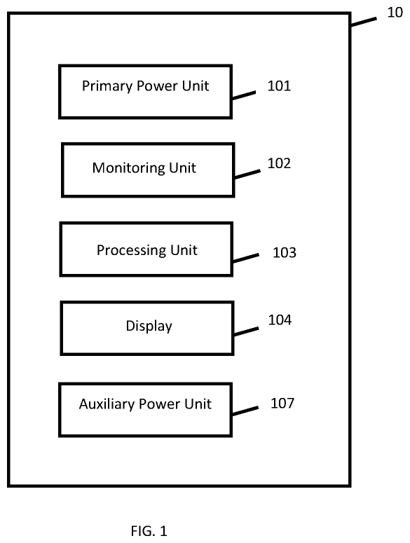

FIG. 1 is a block diagram of device 10 with a primary power unit 101, monitoring unit 102, processing unit 103, a display 104, and an auxiliary power unit 107. Examples of displays that do not require power to continue displaying an image/text include electrophoretic displays such as ePaper displays and eInk displays. Examples of devices with a display may include tablets, e-readers, laptops, smartphones, smartwatches, pagers, smart badges, and other personal/handheld electronic devices.

During normal operation, primary power unit 101 provides the device—including processing unit 103 and display 104—with power. The primary power unit 101 may be an internal power supply and/or an external power supply (e.g. power from an electrical outlet). In some embodiments, the primary power unit 101 may be removed from the device 10. Any suitable power supply may form a part of the primary power unit 101. Some non-limiting examples include a battery (rechargeable/non-rechargeable), a DC power source, and/or an AC power source.

During normal operation, the auxiliary power unit 107 is a backup power unit to supply power to the device when the power level falls below a minimum operating value where the device can no longer operate. In one aspect, the auxiliary power unit 107 provides power to the device when the power state is below a minimum operating value, when the primary power unit battery has been removed, and/or when the device 10 has been unplugged. In these situations, the inclusion of the auxiliary power unit 107 allows the device 10 to remain operational for a period of time so that the display 104 can be updated. In some embodiments, the auxiliary power unit 107 automatically supplies power when the power of the primary power unit 101 falls below a minimum operating value. In one example, the auxiliary power unit 107 provides power for less than one minute after the primary power unit 101 is removed or ceases to function.

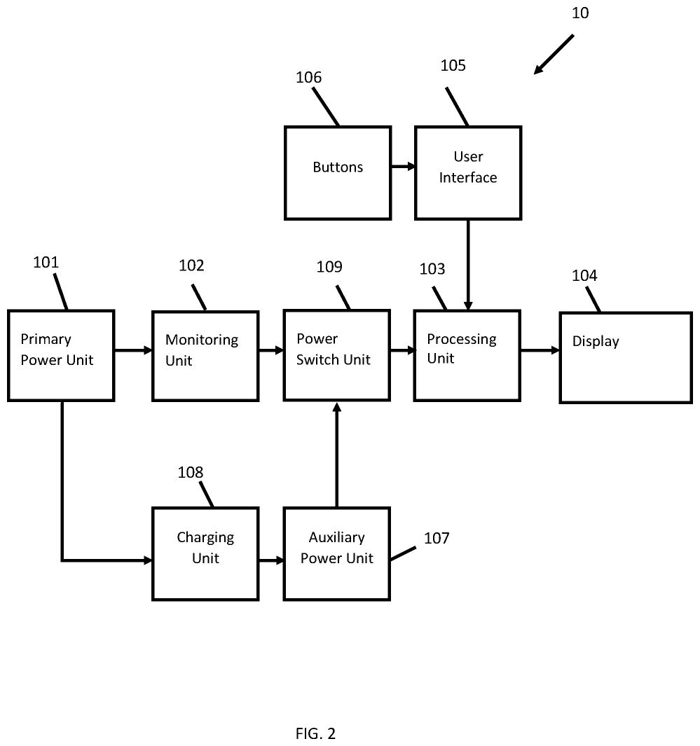

The auxiliary power unit 107 may be an internal device component/unit or an external component in electrical communication with the device 10. An uninterruptible power supply is one example of an external auxiliary power unit. In some embodiments, an external auxiliary power unit provides power to the device through one or more auxiliary power inputs. In at least one embodiment, the auxiliary power unit 107 includes a rechargeable or non-rechargeable battery or a super-capacitor. In some embodiments, the charge on a rechargeable auxiliary power unit may be provided by the charging unit 108 (See FIG. 2). In one embodiment, the primary power unit 101 maintains the charge on the rechargeable auxiliary power unit 107. In at least one embodiment, the auxiliary power unit 107 is integrated into the primary power unit 101. As one example, the auxiliary power unit 107 is a small power reserve in the primary power unit 101.

In some embodiments, monitoring unit 102 is configured to monitor the voltage associated with the primary power unit 101 and provide feedback to the processing unit 103. This feedback may be in the form of telling the processing unit 103 that the voltage is below the minimum operating level, telling the processing unit 103 what the voltage level is, and/or providing the processing unit 103 with the actual voltage input so the processing unit 103 can make a voltage level determination. However, in other embodiments, the monitoring unit 102 may be utilized to monitor additional characteristics of the primary power unit 101. For example, monitoring unit 102 may monitor the state of charge, current, and/or other aspects of the primary power unit 101. The monitoring unit 102 may monitor the primary power unit 101 continuously and/or periodically. In some embodiments, monitoring unit 102 may monitor the primary power unit 101 in response to a request from processing unit 103. In at least one embodiment, the monitoring unit 102 obtains a value for a characteristic of the primary power unit 101. In some embodiments, the monitoring unit 102 is configured to store, evaluate, and/or analyze the data.

In some embodiments, processing unit 103 is configured to execute instructions stored by a memory (not shown) and to communicate with the display 104. In particular, processing unit 103 generates instructions to modify/control the images/text displayed by the display 104. Processing unit 103 may also initiate procedures to turn the device On and Off, for example in response to a user pressing a power button or engaging a switch, and may also be configured to initiate automatic turn-Off in response to a triggering event.

The processing unit 103 and/or monitoring unit 102 may be a central processing unit (CPU), a master control unit (MCU), a graphics processing unit (GPU), an accelerated processing unit (APU), a microprocessor, a microcontroller, a digital signal processor (DSP), a field-programmable gate array (FPGA), an application-specific integrated circuit (ASIC) and/or another type of processor. The processing unit 103 and/or monitoring unit 102 may be implemented in hardware, firmware, or a combination of hardware and software. In some embodiments, the processing unit 103 and monitoring unit 102 are subunits of the device's processor.

In further embodiments, device 10 also includes memory to store instructions to be executed. The memory may be random access memory (RAM), read-only memory (ROM), and/or another type of dynamic or static storage device (e.g., flash memory, magnetic memory, optical memory, etc.) that stores information and/or instructions to be executed.

FIG. 2 is a block diagram of at least one embodiment of the device 10. In some embodiments, device 10 has a power switch unit 109 that directs power to the processing unit 103 from either the primary power unit 101 or the auxiliary power unit 107. In at least one embodiment, the power switch unit 109 automatically switches from the primary power unit 101 to the auxiliary power unit 107. For example, when the power supplied by the primary power unit 101 goes below a minimum operating value, the power switch unit 109 automatically switches power to the auxiliary power unit 107. The power switch unit 109 may include a relay, a semi-conductor switch component (e.g. a transistor or transistor-like component), a steering diode, and/or a circuit. In some embodiments, the power switch unit 109 communicates with the processing unit 103.

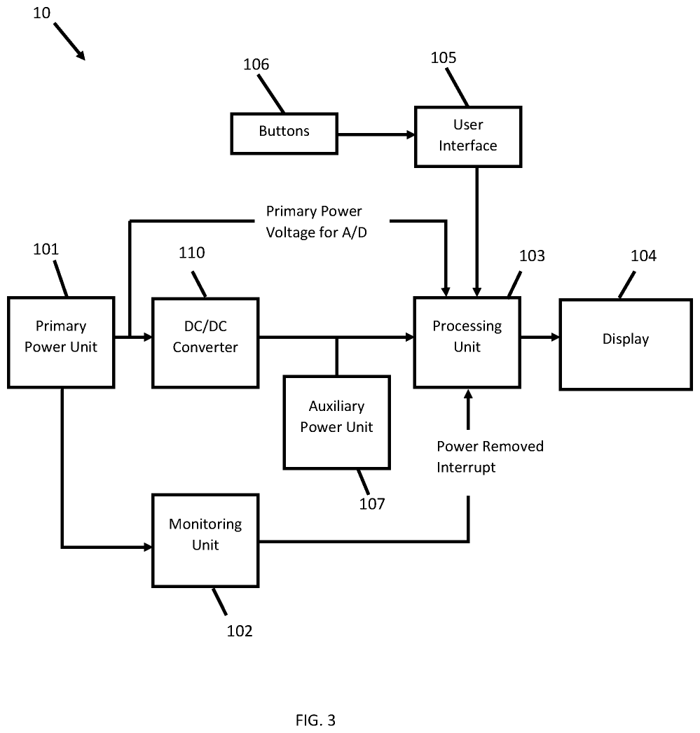

FIG. 3 is a block diagram of at least one embodiment of the device 10. In some embodiments, the primary power unit 101 indirectly maintains the charge on the auxiliary power unit 107. In one example, the primary power unit 101 indirectly maintains the charge on the auxiliary power unit 107 through a DC to DC converter 110. In other embodiments, the primary power unit 101 directly maintains the charge on the auxiliary power unit 107 (not shown). In some embodiments, the primary power unit 101 provides primary power voltage for an analog to digital converter that may be included in the processing unit 103.

In some embodiments, device 10 includes buttons 106 and user interface 105. In some embodiments, buttons 106 may be used to interact with the user interface 105, as shown in FIGS. 2 and 3. In one aspect, the user interface 105 may be used to send an instruction to processing unit 103. For example, user interface 105 may be used to clear the display 104. In some embodiments, the user interface 105 is a part of the display. In another aspect, the user utilizes buttons 106 and/or user interface 105 to turn the device 10 Off by a shut-down protocol.

Display 104 generates an image (e.g., text, images, etc.) that is visible to a user. A characteristic of at least some displays is that they provide static display states that can be maintained without power. Thus, an image or text displayed by display 104 will continue to be displayed—even despite a loss of power—until instructed by processing unit 103 to change or modify the display. To prevent the display 104 from displaying information (e.g., confidential information) when there is a triggering event, processing unit 103 selectively modifies, which may include clearing, the content displayed by the display 104. Examples of triggering events include manually turning a device Off, executing a sleep mode protocol (e.g. if a device is left unattended), an unexpected loss of power (e.g. power outage and/or removal of the primary power unit 101), a power state (e.g. voltage and/or current) below a threshold value, a power state below a minimum operating value, a present power state that is greatly reduced compared to a prior power state, and/or a notification that the auxiliary power unit is supplying power to the device.

In another aspect, a device 10 described herein may execute a method to replace some or all of the content viewable on the display 104 with new content when there is a triggering event. The new content may be a text message, a symbol (e.g. pictogram), an image, a color, and/or a simple clearing of the display. In some embodiments, the new content is a combination of text, symbol(s), image(s), and/or color(s). In other embodiments, the new content includes additional text and/or images such as a company logo, the user's name, and/or help desk information.

In one aspect, the purpose of the new content is to provide status information, explanatory/reason information, and/or restoration information to the user of the device. Status information may inform the user of the status of the device. Explanatory information may inform the user how the device arrived at its present state. Restoration information may provide the user with a course of action to return the device to an On state. In a further aspect, displaying new content protects potentially private content from being displayed on the device 10 when the device loses power or is turned off by replacing the content with new content.

In some embodiments, a secondary notification accompanies the display of new content. In one aspect, the secondary notification alerts the user of a change in the status of the device and/or that action is required. Examples of secondary notifications include an audible notification, such as an alarm or other sound, a text message, and/or an email message. In some embodiments, the secondary notification depends on the new content that is displayed. For example, different types and/or combinations of secondary notifications may be used for different content or triggering events. As another example, the secondary notification provided varies with the urgency of the triggering event. In some embodiments, the secondary notification is sent or communicated to a different device.

In at least one embodiment, a triggering event is identified by data analysis. Data collection and data analysis may be conducted by the same unit or by different units. As one example, monitoring unit 102 may collect and analyze the data. As another example, monitoring unit 102 may collect the data, and processing unit 103 may analyze the data.

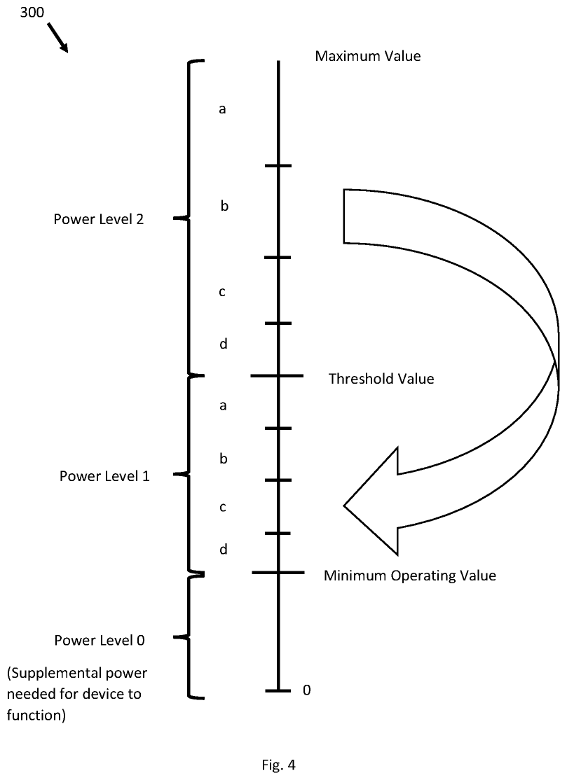

In some embodiments, the data analysis utilizes a power level scale. For the purposes of this discussion, the power level scale may be a scale of voltage, current, or power. In one example, a power level scale is used to determine if there has been an unexpected loss of power and/or when a present power state is greatly reduced to a prior power state. FIG. 4 is an exemplary power level scale 300 with a minimum operating value and a threshold value identified. In at least one embodiment, the threshold value and/or the minimum operating value are based on the operating specifications for the device. For example, the minimum operating value may correspond to a value below which the device cannot function due to insufficient power. In some embodiments, the device continues to receive power from the primary power unit 101 when the power level of the device is below the threshold value. In at least one embodiment, coding is used to implement the device behaviors based on the power level scale concept shown in FIG. 4. Any suitable coding language/protocol may be used to implement a power level scale.

In this exemplary power level scale 300, the primary power unit 101 has three levels of power: power is greater than a threshold value (power level 2), power is less than a threshold value but greater than a minimum operating value (power level 1), and power is less than a minimum operating value (power level 0) (FIG. 4). As shown in FIG. 4, each power level may be subdivided. These divisions may be evenly spaced apart, as shown for Power Level 1, or unevenly spaced apart, as shown for Power Level 2. In some embodiments, the ticks identifying the subdivisions become closer together as the level decreases from the maximum level, as illustrated for Power Level 2. In at least one embodiment, a measured value is assigned to a power level. A large difference between two consecutive measured values can indicate power failure (e.g. battery is removed, device unplugged, or power outage) and/or that the primary power unit 101 is failing. In some embodiments, a power level scale is used to identify a rapid change in the power level. For example, a rapid change in the power level may be defined as a decrease of more than one level between a measured value and the prior measured value, e.g. 1a to 1c, or as indicated by the arrow in FIG. 4.

In other embodiments, the data analysis includes comparing a measured value to another value (e.g. a minimum operating value, a threshold value, and/or a prior measured value), correlating a measured value with an operational state, correlating a measured value with a power level, and/or using the measured value in a calculation to compare a calculated value to a minimum operating value, a threshold value, and/or a prior calculated value.

In at least one embodiment, the device 10 includes circuitry configured to compare the measured value to another value. For example, the circuitry may be comparator logic circuitry. In some embodiments, the circuitry outputs a value correlating to a power level. As one example, the circuitry may output the logic values “11” when the measured value is above a threshold value, the logic value “01” when the measured value is below the threshold value, and the logic value “00” when the measured value is below the minimum operating value. In some embodiments, the monitoring unit 102 includes comparator logic circuitry and outputs the value to the processing unit 103. As another example, the circuitry may output logic value “1” (where 1 is high) when the measured value is above the minimum operating value, the logic value “0” (where 0 is low) when the measured value is below the minimum operating value. In this example, the logic values would be monitored by processing unit 103

In some embodiments, the processing unit 103 may initiate an automatic power-down or power-Off sequence based on the monitored value. For example, in some embodiments, if the monitored value is less than a threshold value (same or different than the threshold value utilized above) then the processing unit 103 initiates an automatic shut-down. In some embodiments, initiating an automatic shut-down includes updating the display. In other embodiments, the display is updated first and then the automatic shut-down is initiated.

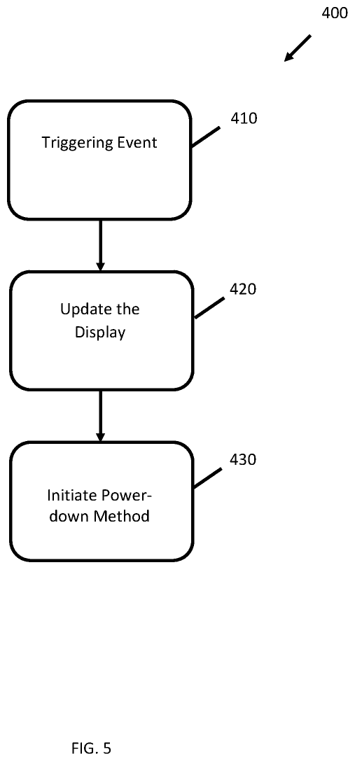

FIG. 5 is a flowchart of an exemplary power-off method 400. In some embodiments, the power-off method 400 provides status information, provides explanatory/reason information, provides restoration information, and/or protects potentially private content being displayed on the device 10 when the device loses power by replacing the display content with new content.

At step 410, a triggering event is detected. At step 420, a unit of the device executes instructions for updating the content on the display 104 with new content. In some embodiments, the processing unit 103 executes instructions for updating the display 104. The new content displayed may depend on the triggering event. Table 1 provides some exemplary triggering events and information conveyed the new content. At step 430, a unit of the device executes a power-down method to reduce power consumption or to simply show that the device is off. In one example, the power-down method includes executing an auto-shutdown protocol. The auto-shutdown protocol may include putting the device into a sleep mode and/or turning the device Off. In some embodiments, the processing unit 103 executes the power-down method.

TABLE 1
Exemplary Triggering Events and New Content to be Displayed

| | New Content Examples | | | |
|---|---|---|---|---|
| Triggering | Status | Explanatory | Restoration | |
| Event | Information | Information | Information | Color |
| Manual Power- | Device is Off. | Device was Turned | Turn Device On | Grey |
| Off | | Off | | Black |
| | | | | White |
| Sleep Mode | Device On | Device in Sleep | Wake Up Device | Blue |
| Protocol | | Mode | | |
| Power State | Device is Off | Battery is Dying | Please Replace | Orange |
| Below Threshold | | | Battery | |
| Value | | | | |
| Power State | Device is Off | Battery Removed | Insert Battery | Red |
| Below Minimum | | Device Unplugged | Plug in Device | |
| Operating Value | | No Power | Plug in Device | |
| Rapid Decrease | Device is Off | Battery is Failing | Replace Battery | Orange |
| in the Power | | Power Source is | Replace Power | |
| State | | Failing | Source | |
| | | | Plug in Device | |

In at least one embodiment, the new content is removed from the display 104 after the power level is restored, e.g. by inserting a new battery/primary power supply or plugging in the device). In some embodiments, the device 10 automatically resumes operation and the status message is replaced with a status message that informs the user that the device is On and/or operational. In other embodiments, the device 10 may need to be turned on manually for the device to resume operation. In other embodiments, the device 10 may automatically resume operation but a user may need to manually acknowledge that the device was Off before the display is completely returned to normal.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A device comprising:
a display;
a monitoring unit configured to obtain a measured value of a power state of the device;
an auxiliary power unit for supplying power to the device when the measured value is less than a minimum operating value;
wherein content on the display is updated with new content when the measured value is less than the minimum operating value.

2. The device of claim 1, wherein the new content replaces content on the display.

3. The device of claim 1, further comprising a power switch unit configured to automatically transfer power from a primary power unit to the auxiliary power unit when the measured value is less than the minimum operating value and to notify a processing unit of the power transfer.

4. The device of claim 2, further comprising a processing unit configured to execute a power-Off method that includes replacing the content on the display.

5. The device of claim 1, wherein the display does not require power to continue displaying content.

6. The device of claim 1, wherein a secondary notification is provided when the new content is displayed.

7. The device of claim 3, further comprising:
a comparator logic circuit configured to output a value, the value including:
a first value when the measured value is less than the minimum operating value; and
a second value when the measured value is greater than the minimum operating value;
a processing unit configured to receive the value and to cause the new content to be displayed on the display when the value is the first value.

8. A processor implemented method for modifying content on a display of a device with a processor, the method comprising modifying the content on the display in response to a power level of the device being below a minimum operating value.

9. The processor implemented method of claim 8, wherein modifying the content includes replacing content on the display with new content.

10. The processor implemented method of claim 8, wherein the display does not need power to maintain content on the display

11. The processor implemented method of claim 8, wherein modifying the content includes displaying status information, explanatory information, and/or restoration information.

12. The processor implemented method of claim 8, the method further comprising determining if an auxiliary power unit is On.

13. A personal electronic device comprising a display that does not require power to continue displaying content, wherein content on the display is selectively modified in response to a triggering event.

14. The personal electronic device of claim 13, wherein the content is selectively modified by being replaced with new content.

15. The personal electronic device of claim 13, wherein the triggering event is a manual power-Off or an execution of a sleep mode protocol.

16. The personal electronic device of claim 13, the device further comprising a primary power unit and an auxiliary power unit, wherein the triggering event is a switch in power supply from the primary power unit to the auxiliary power unit.

17. The personal electronic device of claim 13, the device further comprising a primary power unit having a power state, wherein the triggering event is the power state being below a threshold value, the power state being below a minimum operating value, and/or a rapid decrease in the power state.

18. The personal electronic device of claim 17, wherein the rapid decrease in the power state is determined by a power level scale.

19. The personal electronic device of claim 17, wherein the device includes:
a circuit configured to compare the power state to the threshold value and to the minimum operating value and output a first value when the power state is below the threshold value and a second value when the power state is below the minimum operating value; and
a processing unit configured to selectively modify the display with new content, wherein new content displayed in response to the first value is different from new content displayed for the second value.

20. The personal electronic device of claim 13, wherein the new content displayed depends on the triggering event.
